(19) United States
(12) Patent Application Publication
(10) Pub. No.: US 2013/0155463 A1
(43) Pub. Date: Jun. 20, 2013

(54) METHOD FOR SELECTING USER DESIRABLE CONTENT FROM WEB PAGES

(71) Applicants: Jian-Ming Jin, Beijing (CN); Liwei Zheng, Beijing (CN); Xi Wang Zhuang, Beijing (CN); Suk Hvan Lim, Mountain View, CA (US); Hui-Man Hou, Beijing (CN)

(72) Inventors: Jian-Ming Jin, Beijing (CN); Liwei Zheng, Beijing (CN); Xi Wang Zhuang, Beijing (CN); Suk Hvan Lim, Mountain View, CA (US); Hui-Man Hou, Beijing (CN)

(21) Appl. No.: 13/812,104

(22) PCT Filed: Jul. 30, 2009
(86) PCT No.: PCT/CN10/75591

§ 371 Date: Jan. 24, 2013

(51) Int. Cl. G06F 3/0484; G06F 3/12

(52) U.S. Cl. CPC G06F 3/04842; G06F 3/12
USPC 358/1.15; 715/760

(57) ABSTRACT

A method for selecting user desirable content from web pages includes receiving a web page, representing the web page as a Document Object Module (DOM) tree, computing visual and coordinate information of each Document Object Module (DOM) node within the Document Object Module (DOM) tree, determining the desirable Document Object Module (DOM) path, determining the desirable Document Object Module (DOM) node from the desirable Document Object Module (DOM) path, and selecting a single Document Object Module (DOM) node with the highest final score. The single Document Object Module (DOM) node with the highest final score is selected as the user desirable content of the webpage.

### BACKGROUND

Web pages provide an inexpensive and convenient way to make information available to the viewers of those web pages. However, as the inclusion of multimedia content, embedded advertising, and online services becomes increasingly more prevalent in modern web pages, the web pages themselves have become substantially more complex. For example, in addition to their main content, many web pages display auxiliary content such as background imagery, advertisements, and navigation menus, as well as separate links to additional content.

It is often the case that owners or viewers of web pages wish to view, utilize or adapt only a portion of the information presented in a web page. Such uses of only a portion of the content presented in a web page can require tedious effort on the part of a user to distinguish among the different types of content on the web page and retrieve only that user desirable content. Automatic selection of the user desirable content in web pages can eliminate extraneous or undesired content and significantly streamline a number of workflows. For instance, a user may desire to print a physical copy of an internet article without reproducing any of the irrelevant content on the web page on which the article is being displayed. Similarly, an owner of a web page may wish to adapt a web page into another document, such as a marketing brochure, without including content in the web page that is superfluous to the new document. Still further, a user may wish to display only the most relevant web content on a computing device with a limited screen size. Other applications which may benefit from automatic selection of the user desirable content in web pages include: search, information retrieval, information management, archiving, and other applications.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative system for selection of user desirable content in a web page, according to one embodiment of principles described herein.

FIG. 2A is a Document Object Model (DOM) tree for an illustrative web page, according to one embodiment of principles described herein.

FIG. 2B is a layout of an illustrative web page which corresponds to the DOM tree of FIG. 2A, according to one embodiment of principles described herein.

FIG. 2C is diagram of an illustrative web page showing the content of the web page, according to one embodiment of principles described herein.

FIGS. 3A and 3B in combination are an illustrative flowchart depicting a method of extracting user desirable web content by selecting the best Document Object Module (DOM) sub-tree, according to one embodiment of the principles described herein.

Throughout the drawings, identical reference numbers designate similar, but not necessarily identical, elements.

### DETAILED DESCRIPTION

The present specification discloses various methods, systems, and devices for automatically finding the Document Object Model (DOM) sub-tree which has the user desirable content of a web page. As discussed above, there are many applications where automatically selecting the user desirable part of a web page can be advantageous. For purposes of explanation, the specification uses the illustrative example of selecting the user desirable part of a web page to enhance the printing of the web page. Currently, when a web page is printed, it includes a variety of contents. For example, in addition to the main content, many web pages display content such as background imagery, advertisements, or navigation menus, headers/footers, and links to additional content. Some of the content within the webpage may be print worthy, but the user may not want to print some or all of the auxiliary contents. Ideally, only the content desired by the user is selected and presented to the user for printing.

Various challenges arise when attempting to automatically select the user desirable content in a web page. For example, website templates can be manually created in advance of content being placed therein. However, many varying types and forms of templates may exist amongst the web pages throughout the World Wide Web. Additionally, some web pages may simply be arbitrary and not include a specific template or any template at all.

Still further, web pages may also include a variety of content, including text, images, video and flash objects. To effectively select the “main” content in a web page such as in a news web page, an algorithm may determine not only a relative ordering of importance of content but also an absolute determination whether content can be categorized as “main” content. This method however, varies greatly depending on the algorithm used and may vary greatly in results.

Finally, segmentation of the web page into different semantic blocks by using other types of algorithms may be prove to be ineffective. Specifically, this method provides various results which again depend greatly on the algorithm used.

As used in the present specification and in the appended claims, the term “web page” refers to a document that can be retrieved from a server over a network connection and viewed in a web browser application.

As used in the present specification and in the appended claims, the term “node” refers to one of a plurality of coherent units into which the entire content of a web page has been partitioned.

As used in the present specification and in the appended claims, the term “leaf node” refers to a node which has zero child nodes or any lower level nodes.

As used in the present specification and in the appended claims, the term “coherent,” as applied to a node, refers to the characteristic of having content only of the same type or property.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

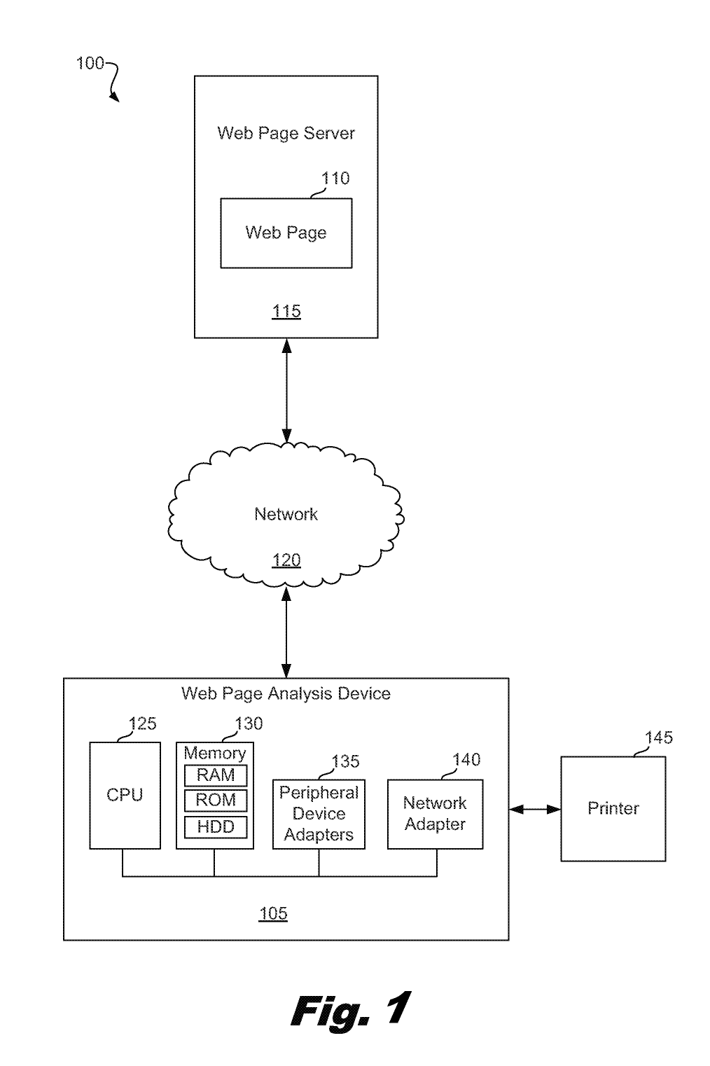

Referring now to FIG. 1, an illustrative system (100) for automatic selection of user desirable content in web pages includes a web page analysis device (105) that has access to a web page (110) stored by a web page server (115). In the present example, for the purposes of simplicity in illustration, the web page analysis device (105) and the web page server (115) are separate computing devices communicatively coupled to each other through a mutual connection to a network (120). However, the principles set forth in the present specification extend equally to any alternative configuration in which a web page analysis device (105) has complete access to a web page (110). As such, alternative embodiments within the scope of the principles of the present specification include, but are not limited to, embodiments in which the web page analysis device (105) and the web page server (115) are implemented by the same computing device, embodiments in which the functionality of the web page analysis device (105) is implemented by multiple interconnected computers (e.g., a server in a data center and a user's client machine), embodiments in which the web page analysis device (105) and the web page server (115) communicate directly through a bus without intermediary network devices, and embodiments in which the web page analysis device (105) has a stored local copy of the web page (110) which is to be analyzed to automatically select desirable content from the web page (110).

The web page analysis device (105) of the present example is a computing device configured to retrieve the web page (110) hosted by the web page server (115) and automatically find the best Document Object Model (DOM) node which contains the user desirable contents of the web page. In the present example, this is accomplished by the web page analysis device (105) requesting the web page (110) from the web page server (115) over the network (120) using the appropriate network protocol (e.g., Internet Protocol (“IP”)). Illustrative processes for automatically finding the best Document Object Model (DOM) node containing the user desirable contents of the web page are set forth in more detail below.

To achieve its desired functionality, the web page analysis device (105) includes various hardware components. Among these hardware components may be at least one processing unit (125), at least one memory unit (130), peripheral device adapters (135), and a network adapter (140). These hardware components may be interconnected through the use of one or more busses and/or network connections.

The processing unit (125) may include the hardware architecture necessary to retrieve executable code from the memory unit (130) and execute the executable code. The executable code may, when executed by the processing unit (125), cause the processing unit (125) to implement at least the functionality of retrieving the web page (110) and analyzing a web page (110) in order to automatically find the best Document Object Model (DOM) node which contains the user desirable contents of the web page according to the methods of the present specification described below. In the course of executing code, the processing unit (125) may receive input from and provide output to one or more of the remaining hardware units.

The memory unit (130) may be configured to digitally store data consumed and produced by the processing unit (125). The memory unit (130) may include various types of memory modules, including volatile and nonvolatile memory. For example, the memory unit (130) of the present example includes Random Access Memory (RAM), Read Only Memory (ROM), and Hard Disk Drive (HDD) memory. Many other types of memory are available in the art, and the present specification contemplates the use of many varying type(s) of memory (130) in the memory unit (130) as may suit a particular application of the principles described herein. In certain examples, different types of memory in the memory unit (130) may be used for different data storage needs. For example, in certain embodiments the processing unit (125) may boot from ROM, maintain nonvolatile storage in the HDD memory, and execute program code stored in RAM.

The hardware adapters (135, 140) in the web page analysis device (105) are configured to enable the processing unit (125) to interface with various other hardware elements, external and internal to the web page analysis device (105). For example, peripheral device adapters (135) may provide an interface to input/output devices to create a user interface and/or access external sources of memory storage. Peripheral device adapters (135) may also create an interface between the processing unit (125) and a printer (145) or other media output device. For example, in embodiments where the web page analysis device (105) is configured to select the best Document Object Model (DOM) node which contains the user desirable contents of the web page and then print that content, the web page analysis device (105) may be further configured to instruct the printer (145) to create one or more physical copies of the document. A network adapter (140) may additionally provide an interface to the network (120), thereby enabling the transmission of data to and receipt of data from other devices on the network (120), including the web page server (115).

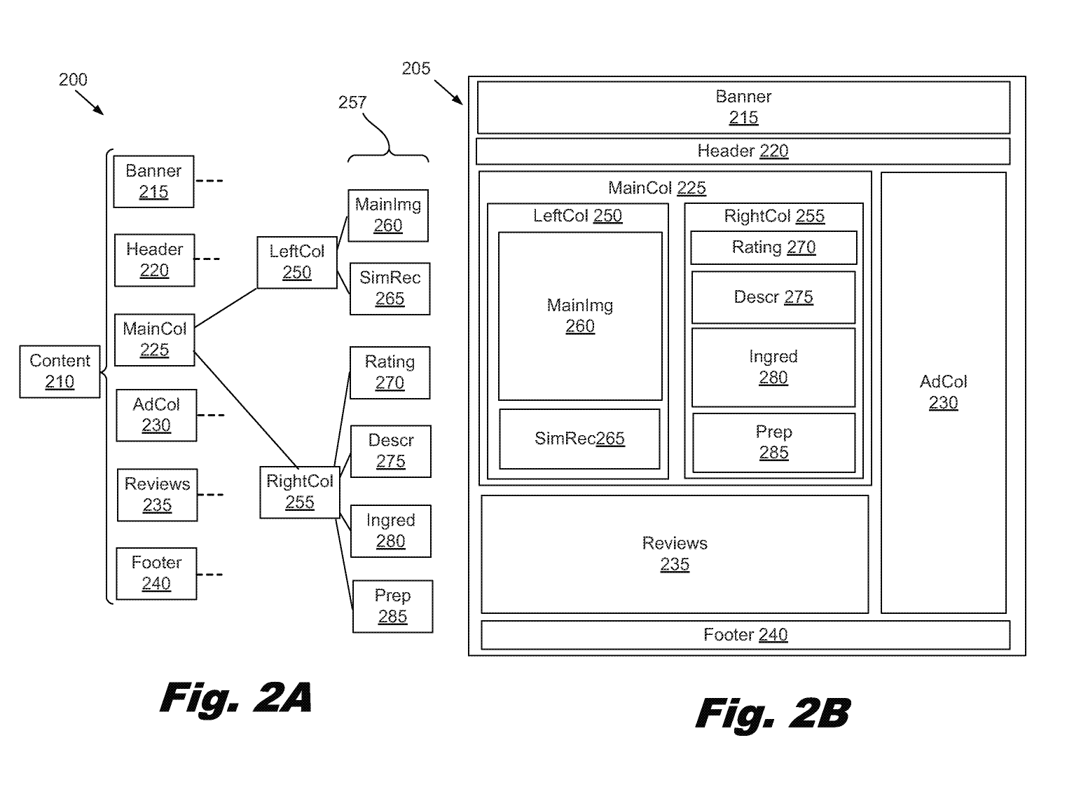

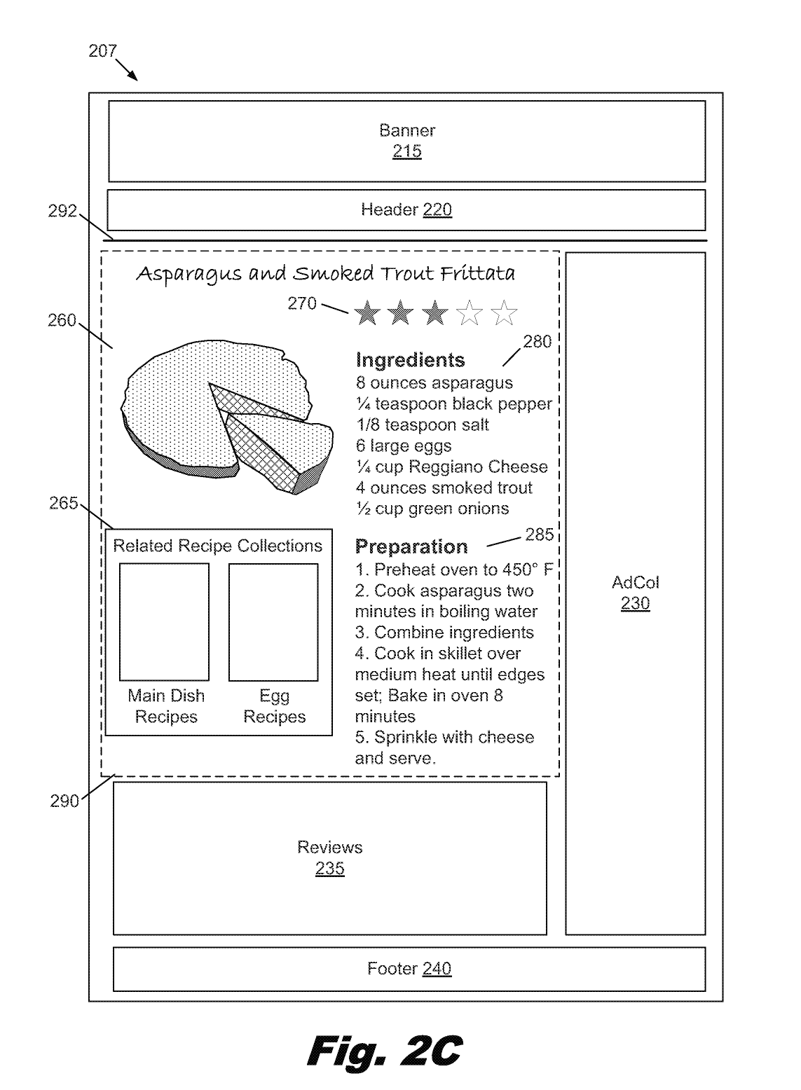

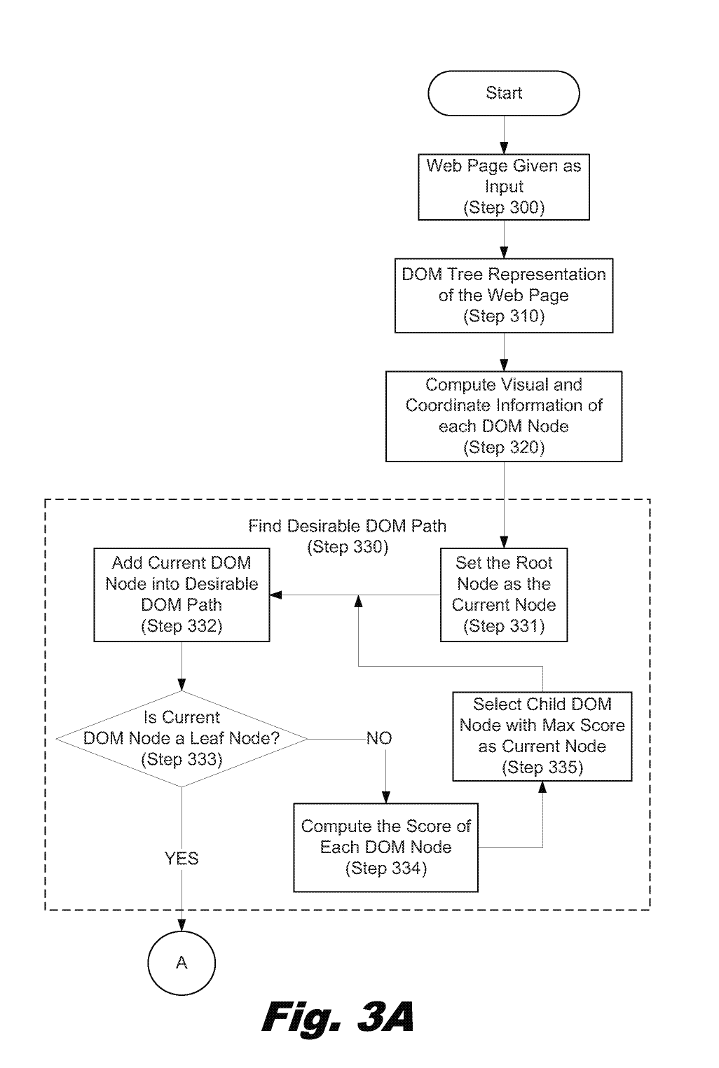

Referring now to FIGS. 2A-2C, illustrative diagrams which illustrate the Document Object Model (DOM), layout, and visual elements in a web page is shown. In this example, the web page is from a recipe website and includes an image of the dish which is described, a rating of the dish by users, a description of the dish, ingredients to make the dish, preparation instructions, and other elements.

FIG. 2A is an illustrative Document Object Module (DOM) tree which shows the hierarchy of Document Object Module (DOM) nodes in an illustrative web page. A Document Object Module (DOM) is a cross-platform and language independent convention for representing and interacting with web page elements in HyperText Markup Language (HTML), eXensible HyperText Markup Language (XHTML) and eXensible Markup Language (XML). The root node in this illustrative web page is the Content node (210) which has six sub-trees: Banner (215); Header (220), MainCol (225); AdCol (230); Reviews (235); and Footer (240). For purposes of illustration, sub-nodes (250-285) are shown for only for the MainCol sub-tree (225). Dashed lines extending to the right of the other sub-trees show the continuation of the sub-trees with nodes which are not illustrated in FIG. 2A.

The MainCol sub-tree (225) has two nodes, LeftCol (250) and RightCol (225), at the next hierarchal level. LeftCol (250) has two nodes at the lowest hierarchal level: MainImg (260) and SimRec (265). The RightCol (225) has four nodes at the lowest hierarchal level: Rating (270), Descr (275), Ingred (280), and Prep (285).

FIG. 2B shows the layout (205) of the web page. The Banner (215) and AdCol (230) reserves location in the layout (205) for a banner ad and other advertisements. The Header (220) may contain a number of elements including navigation tabs, search fields and other sub-elements. Similarly the Footer (240) may contain a number of elements including links to related sites, terms of use and privacy policies, copyright notices, and other elements. The Review sub-tree (235) contains ratings and comments from various users of the site who have tried the recipe.

The MainCol (225) sub-tree contains the user desirable content which a user would typically want to print or archive for further reference. The MainCol (225) contains a left column (250) and a right column (225). In left column (250), an image of the dish is shown in the MainImg element (260). Similar recipes are shown below the image in the SimRec element (265). The right column (255) includes an overall rating for the dish (270), a description of the dish (275), ingredients of the dish (280), and preparation instructions (285). These elements (260-285) may have a number of additional sub-elements.

FIG. 2C shows the web page (207) with the visible content of the MainCol (225, FIG. 2B) sub-tree shown in more detail. The content has been simplified for purposes of illustration. There may be a variety of non-visual code and/or elements present in the MainCol (225, FIG. 2B). However, according to one aspect of the present systems and methods this non-visual information is not presented to the user when the recipe is printed. Consequently, during the analysis of the web page to determine the user desirable content of the web page, non-visual information is not weighted heavily or is not considered at all. As discussed above, when printing or archiving, the user is typically interested in preserving, printing or copying the main content of the page. Banner ads, page navigation, reviews, and links typically contain information which is not directly relevant to the user's interest in the page and are not directly related to the content the user wishes to preserve. As used in the specification and appended claims, the term “user desirable content” refers to visual web page content which a user would typically like to preserve, print, or copy for future reference. In general, the user desirable content is the essence of the web page and may include text, pictures, icons, or other information.

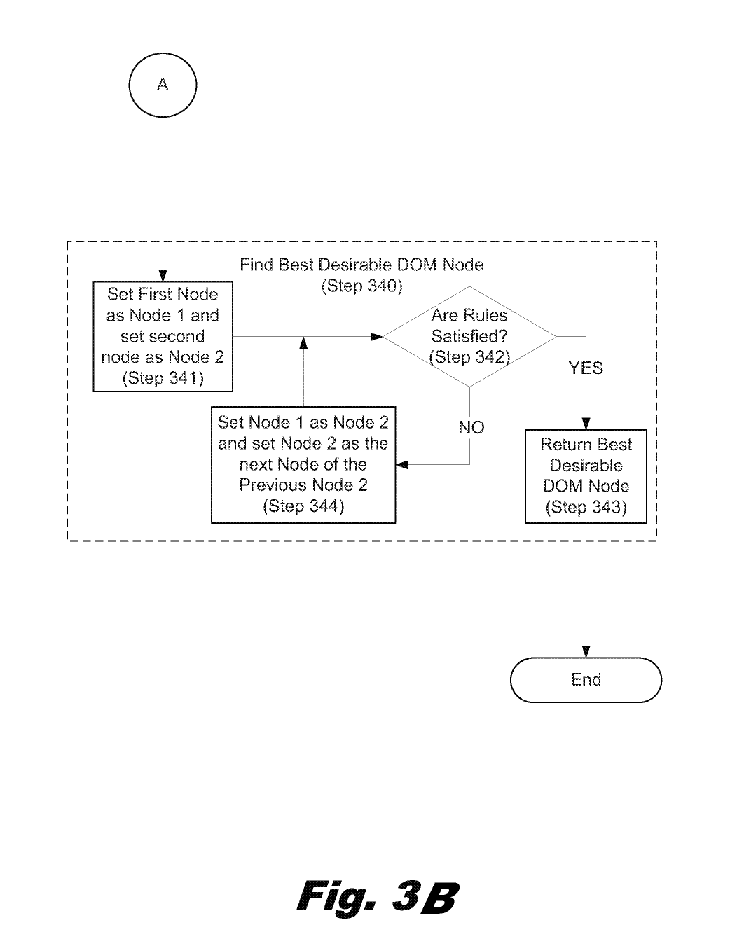

Turning now to FIGS. 3A and 3B, an illustrative flowchart depicting a method of extracting user desirable web content by selecting the best Document Object Module (DOM) sub-tree is shown. The method may be implemented by a processor (FIG. 1, 125) running a user desirable content selection algorithm which has been stored on a memory device (FIG. 1, 130). The method includes providing a web page (FIG. 1, 110) as input (Step 300) to the web page analysis device (FIG. 1, 105). According to one embodiment, a browser rendering engine then parses and renders the Web Page (Step 310) which results to the web page being represented as a Document Object Model (DOM) tree.

Next, visual and coordinate information of each Document Object Module (DOM) node is computed (Step 320). In one embodiment, a software product for obtaining the rendering coordinates of visible Document Object Module (DOM) nodes on a web page may comprise three modules: a tag wrapper module, a coordinate calculator module, and an invisible Document Object Module (DOM) node filter. The modules work together to produce a data structure containing details of the Document Object Module (DOM) nodes and their coordinates, in which the invisible Document Object Module (DOM) nodes are filtered out. To do this, the tag wrapper module queries each Document Object Module (DOM) node of a data structure representing a web page rendered by a browser using a Document Object Module (DOM) Application Program Interface (API). Thus, the tag wrapper module waits until any Cascading Style Sheet (CSS) information has been applied to the HTML and until any scripts (such as JavaScript) have been executed. The tag wrapper module then wraps each Document Object Module (DOM) node in a pair of HTML tags. It produces a JavaScript Object Notation (JSON) data structure as output, which comprises all the Document Object Module (DOM) nodes wrapped in the HTML tags (along with all the other nodes representing the HTML). Under some circumstances, as described below, the web page may be re-rendered to incorporate the wrapped Document Object Module (DOM) nodes correctly. If this is done then the tag wrapper module adds the pairs of HTML tags to the Document Object Module (DOM) nodes in the data structure via the Document Object Module (DOM) Application Program Interface (API) and then instructs the browser to re-render the web page including the additional pairs of HTML tags. The JavaScript Object Notation (JSON) data is then received by the coordinate calculator module. The coordinate calculator module then obtains coordinates for each Document Object Module (DOM) node and attaches them as attributes to the data structure via the Document Object Module (DOM) Application Program Interface (API). Finally, the invisible Document Object Module (DOM) node filter determines whether each Document Object Module (DOM) node is invisible and if it is, it excludes the node from an output data structure, which is in the form of a list of visible Document Object Module (DOM) nodes to which are attached the coordinates calculated by coordinate calculator module (along with any other attributes already present from the original data structure). Alternatively, or in addition, the data structure may be modified by deletion of the invisible Document Object Module (DOM) nodes. As will be described later, the Document Object Model (DOM) node coordinates and visual information are used to compute the score of a Document Object Model (DOM) node.

Next the user desirable Document Object Model (DOM) path of the input web page (FIG. 1, 110) is found (Step 330). This step is accomplished by first setting the root node of the Document Object Module (DOM) tree as a current node to work from (Step 331). With the current node now being selected it is then added into the user desirable Document Object Module (DOM) path (Step 332). At this point a decision is made as to whether the current Document Object Module (DOM) node is a leaf node (Step 333). That is, if the current Document Object Module (DOM) node is not a leaf node (Step 333, Determination NO) then the system computes the score of each Document Object Module (DOM) sub-tree (Step 334). The computation of the score (Step 334) may be based on previously set configurable rules.

It should be noted that any single rule or combinations of rules may be implemented to adjust or set the score of any given node. Therefore, it is contemplated by the present application that various rules may result in various scores which may be accumulated to form one score for any particular node. In the alternative, a single rule may be implemented and a score may be used for and set as the score for that particular node through the use of that single rule.

It should be further noted that any rules used in this method may be pre-defined and configured by the user previous to a web page (FIG. 1, 110) being given as input (Step 300). Additionally, the rules used may be configured by the user according to the specific application scenario discussed above. For example the rules used in this method may depend on whether the user desires to print a physical copy of an internet article or adapt a web page into another document without reproducing any of the irrelevant content on the web page containing the article.

Some exemplary rules will now be discussed in connection with computing the score (Step 334) or each Document Object Module (DOM) sub-tree or child Document Object Module (DOM) node. One exemplary rule may be a rule which determines the text length found in the node. Therefore, the length of text found within any one node may determine whether a large or small score is given for that node. For example, where more text is found within the node, a large score may be given for that node. Conversely, little or no text within the node may result in a small score for that node.

Alternatively, or additionally, a score may be at least partially dependent on the ratio of any links within a particular node to the amount of text within that node. Therefore, where the link/text ratio is large, the node may receive a smaller score and where the link/text ratio is small the node may receive a larger score.

Alternatively, or additionally, a score may be given based on the ratio of highlighted text within the node to the rest of the text. The larger the highlighted text/regular text ratio is, the larger the node score is.

Alternatively, or additionally, a score may be given based on the area of the bounding box or block within the node. Therefore, where the bounding box is relatively larger within that node compared to other nodes, a larger node score is given for that node.

Alternatively, or additionally, a score may be given based on the horizontal position of the bounding box or block. Therefore, for a node which includes a bounding box that is relatively nearer to the horizontal center of the web page (FIG. 1, 110) compared to other nodes, a larger node score may be given for that node.

Alternatively, or additionally, a score may be given based on the vertical position of the bounding box or block. Therefore, for a node which includes a bounding box that is relatively nearer to the vertical center of the web page's (FIG. 1, 110) first display screen a larger node score may be given for that node.

Alternatively, or additionally, a score may be given based on the child node count for that particular node. For instances, where a particular node has a relatively larger amount of child nodes compared to other nodes, a larger node score may be given for that particular node.

After the score has been computed for each Document Object Module (DOM) sub-tree (Step 334), the Document Object Module (DOM) node having the maximum score is selected (Step 335). This selected Document Object Module (DOM) node is then added into the desirable Document Object Module (DOM) path (Step 332) and it is again decided whether that node is a leaf node (Step 333).

If the current Document Object Module (DOM) node is a leaf node (Step 333, Determination YES), this method continues from FIG. 3A to FIG. 3B indicated by “A” wherein the best desirable Document Object Module (DOM) node from the desirable Document Object Module (DOM) path is found (Step 341). This step is accomplished by setting the first node found in the desirable Document Object Module (DOM) path as Node 1 (Step 341). The second node found in the desirable Document Object Module (DOM) path is further set as Node 2 (Step 341). A decision is then made as to whether or not the rules for computing the best desirable Document Object Module (DOM) node have been satisfied (Step 342). For example, a rule may be set to determine whether the ratio of the area of Node 2 to the area of Node 1 is smaller than a predefined threshold. This is known as the area ratio.

Additionally or in the alternative, a rule may be set to determine whether the ratio of the printable score of Node 2 to the printable score of Node 1 is smaller than a separate predefined threshold. This may be know as the desirable score ratio.

Additionally or in the alternative, a rule may be set to determine whether the ratio of the height of Node 2 to the height of Node 1 is smaller than a separate predefined threshold. This may be known as the bounding box height ratio.

If none of these rules have been satisfied (Step 342, Determination NO), the Node 1 and Node 2 have different nodes assigned to them. Specifically the node previously set as Node 1 is now set as Node 2 and the next node found in the desirable Document Object Module (DOM) path is set as Node 2. Again, a decision is then made as to whether or not the rules for computing the best desirable Document Object Module (DOM) node have been satisfied (Step 342) for this new set of nodes and the system continues through any number of iterations until at least some of the rules have been satisfied (Step 342, Determination YES). This therefore returns the best desirable Document Object Module (DOM) node (Step 343) within the Document Object Module (DOM) tree.

In conclusion, the specification and figures describe (insert title/claim 1 preamble). (Insert a sentence or two about the novelty/operation if required, mimic dam 1 language if possible). This (title) may have a number of advantages, including: (advantages, focused on known advantages over prior art).

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for selecting user desirable content from web pages comprising:
receiving a web page;
representing the web page as a Document Object Module (DOM) tree;
computing visual and coordinate information of each Document Object Module (DOM) node within the Document Object Module (DOM) tree;
determining the desirable Document Object Module (DOM) path;
determining the desirable Document Object Module (DOM) node from the desirable Document Object Module (DOM) path; and
selecting a single Document Object Module (DOM) node with the highest final score.

2. The method according to claim 1 in which computing visual and coordinate information of each Document Object Module (DOM) node within the Document Object Module (DOM) tree further comprises disregarding invisible Document Object Module (DOM) nodes.

3. The method according to claim 1, in which determining the desirable Document Object Module (DOM) path is performed by scoring nodes within the web page.

4. The method according to claim 3, in which scoring nodes within the web page is performed by assigning a score to a node within the Document Object Module (DOM) tree based on user configured rules.

5. The method according to claim 4, in which the user configured rules are based on considerations which may comprise at least one of a text length within a node, a link to text ratio of a node, a highlighted text to un-highlighted text ratio of a node; a bounding box area of a node, a horizontal position of a bounding box within a node, a vertical position of a bounding box within a node, the number of child nodes associated with a node, and combinations thereof.

6. The method according to claim 1, in which determining the desirable Document Object Module (DOM) path further comprises the steps of:
setting the root node of the web page as a current Document Object Module (DOM) node;
adding the current Document Object Module (DOM) nodes into the desirable Document Object Module (DOM) path; and
determining whether the current Document Object Module (DOM) node is a leaf node.

7. The method according to claim 6, in which, if the Document Object Module (DOM) node is not a leaf node, a score is computed and assigned to each Document Object Module (DOM) node within the Document Object Module (DOM) tree and the child Document Object Module (DOM) node with the maximum score is set as the current Document Object Module (DOM) node.

8. The method according to claim 6, in which, if the Document Object Module (DOM) node is a leaf node, that Document Object Module (DOM) node is used as the root Document Object Module (DOM) node for purposes of determining the desirable Document Object Module (DOM) node from the desirable Document Object Module (DOM) path.

9. The method according to claim 1, in which determining the desirable Document Object Module (DOM) node further comprises the steps of:
setting the first node in the desirable Document Object Module (DOM) path as a first node;
setting the second node in the desirable Document Object Module (DOM) path as a second node; and
determining whether rules for determining the desirable Document Object Module (DOM) node have been satisfied.

10. The method according to claim 9, in which, if the rules for determining the desirable Document Object Module (DOM) node have been satisfied, the first node is set as the desirable Document Object Module (DOM) node.

11. The method according to claim 9, in which, if the rules for determining the desirable Document Object Module (DOM) node have not been satisfied, the second node in the desirable Document Object Module (DOM) path is set as the first node, and the next node following the second node on the Document Object Module (DOM) path is set as the second node.

12. The method according to claim 1, further comprising outputting the desirable Document Object Module (DOM) node.

13. A method of selecting user desirable content from a web page for printing comprising:
receiving a web page;
representing the web page as a Document Object Module (DOM) tree;
computing visual and coordinate information of each Document Object Module (DOM) node within the Document Object Module (DOM) tree;
determining the desirable Document Object Module (DOM) path;
determining the desirable Document Object Module (DOM) node from the desirable Document Object Module (DOM) path; and
selecting a single Document Object Module (DOM) node with the highest final score; and
outputting the user desirable content to a printer for printing.

14. The method according to claim 13, in which determining the desirable Document Object Module (DOM) path is performed by scoring nodes within the web page.

15. A web page analysis device for selection of the user desirable content of a web page comprising:
a memory for storing a user desirable content selection algorithm for selection of user desirable content from a web page;
a processing unit for accepting the user desirable content selection algorithm from the memory and executing the user desirable content selection algorithm; and
a network adapter for receiving a web page from a web page server.
